(19) United States
(12) Patent Application Publication
(10) Pub. No.: US 2008/0318020 A1
(43) Pub. Date: Dec. 25, 2008

(54) Attachment System for Reinforcing Glass Yarns

(76) Inventor: Yohann Barnaud, Chambery (FR)

Correspondence Address: OWENS CORNING, 2790 COLUMBUS ROAD, GRANVILLE, OH, 43023, US

(21) Appl. No.: 11/816,048

(22) PCT Filed: Feb. 14, 2006
(86) PCT No.: PCT/FR06/50131

§ 371 Date: Jul. 30, 2008

(30) Foreign Application Priority Data
Feb. 15, 2005 (FR) 0550425

(51) Int. Cl. C03C 27/10

(52) U.S. Cl. 428/221; 156/158; 156/73.5; 428/325

(57) ABSTRACT

The invention relates to a method of connecting the ends of at least two glass yarns, in which the ends are impregnated with a material comprising a thermoplastic or thermosetting material or with a mixture of a thermoplastic material and a thermosetting material in an overlapping area which is calibrated using calibration means such as a mould/counter-mould assembly. According to the invention, the material is introduced into the calibration means either in the molten form or in the solid form. The overlapping zone of said material and the ends of the yarns is subsequently subjected to means for the at least partial and preferably-complete fusion of the material. The invention also relates to the continuous filament yam that can be obtained using said method and to the use of one such yam in a method in which it is used under strong tensile strain and/or in which it is passed through a calibrated nozzle.

The invention relates to the field of glass fibers, more particularly for use as reinforcement in matrices of the thermoplastic or thermoset, preferably thermoplastic, type. More particularly, the invention relates to the use of reinforcing glass strands, for example rovings in continuous processes for manufacturing composite elements. In the rest of the description, no difference will be made between strand and roving.

Depending on the nature of the desired mechanical properties in a composite, typically comprising a plastic matrix reinforced with glass fibers, it is known that the latter may take various forms, in particular depending on the way they are introduced into the matrix. Thus, there are rovings, also called direct rovings, consisting of an untwisted assembly of parallel filaments. The glass filaments obtained by mechanical drawing are not twisted, but held parallel to one another so as to form a relatively wide and flattened ribbon. The base strand is coated during its production with a size, the main functions of which are to enhance the abrasion resistance of the strand, to maintain bonding between the filaments and to ensure compatibility and bonding between the matrix and the reinforcement during subsequent impregnation phases.

After manufacture, the roving is in general in the form of a coil with or without a tube. Within the context of the present invention, it does not matter whether the roving can be paid out from the inside or the outside. For example, it is in the form of a coil paid out from the inside, or a bobbin when paid out from the outside, the presentation of the bobbin very often being with a tube. Depending on the processes for which they are intended, the rovings may be divided into two main groups, namely rovings for being chopped, that is to say intended to be chopped during subsequent operations, for example in spraying processes, perform and prepreg mat manufacturing processes, continuous molding processes, etc., and rovings in package form, that is to say intended, after being wound, to be used directly without being chopped in subsequent processes for manufacturing a composite part (for example in pultrusion processes), or for downstream conversion of the roving (for example in weaving processes and in the manufacture of textile surfaces, such as knitting and weaving) or the manufacture of chopped or continuous strand mat.

In particular, in the latter use, mention may be made of hot-melt processes in which the aim is for example to obtain long-fiber granulates using a process of the thermoplastic pultrusion type or direct long-fiber processes, often called D-LFT (direct long-fiber thermoplastic) processes which do not require the use of semifinished products. These D-LFT direct processes are used to obtain long-fiber composites by injection molding or compression molding. According to these processes, the continuous strand is introduced directly into an extruder, allowing the strand to be chopped and impregnated with the thermoplastic matrix. The D-LFT processes then comprise a step of injection-molding or compression-molding this compound obtained, resulting in the direct production of a composite part. For more details about these processes and their implementation, the reader may refer for example to the reference works “Techniques de l'ingénieur, Traité plastiques et composites [Engineering Techniques: Treatise on plastics and composites], A 3720” or “Technologie des composites [Composites Technology]” by M. Reyne, published by Hermes, 1998.

Without being limited thereto, the present invention is particularly applicable in the latter processes. In particular, and as will be described in the rest of the description, the invention has many advantages when implementing such processes.

More particularly, the method according to the invention makes it possible to join two glass strands together, for example between two roving packages, and thus makes it possible to pass from one package to another without stopping the manufacturing or conversion process in which it is involved.

To obtain such a coupler, two methods are known and used at the present time.

According to a first method, the one most commonly used, two glass fiber (textile, roving, etc.) packages are fastened together by a pneumatic system. This system is used more widely in the textile industry, and known as the “air splice” system and commercialized in France, for example by the company Mesdan.

The rovings of the packages that have to be joined together are made up of a multitude of filaments. The two rovings are placed against each other over a length of about 10 cm, and application of compressed air makes it possible for the two rovings to be intermingled and thus for the join to be obtained.

In a second method, the join is made during a first step using the above system. The difference derives from the fact that this initial join made up of intermingled rovings is then wrapped with another element, such as one or more textile yarns, for example polypropylene or polyamide yarn. The wrapping carried out makes it possible, on the one hand, to protect the join, in particular from abrasion, and, on the other hand, to substantially increase its tensile strength.

In both cases, the mechanical properties obtained after joining the filaments of the two rovings by intermingling them are insufficient to withstand the stresses on the glass strands in the various processes in which they have to be continuously used under tension and in which the transfer from one glass-fiber package to another must be accomplished without stopping the fiber conversion or composite manufacturing process.

The observed insufficiencies fall within three categories:

a) too low a tensile strength, that is to say a tensile strength value insufficient for the intended application:

By “simple” intermingling of the filaments of the two glass fiber rovings that are joined together creates a tensile strength in the join that is 40% lower than the tensile strength of the glass fiber roving itself, that is to say without said join. In general, it is observed that the tensile strength is usually around 30% of the strength of the fiber. The second method, in which an additional wrapping is applied, does not improve the tensile strength sufficiently to allow use in the abovementioned processes. Thus, the measured tensile strength of the join at best reaches only 45% of the tensile strength of the initial strand.

Furthermore, the longer the join obtained by the air-splice system and the shorter the intermingling of the filaments, the lower the tensile strength of the join, thereby occasioning very long joins;

b) the presence of a substantial overthickness:

Producing a join by intermingling results at least in a doubling of the thickness of the join relative to the initial thickness of the roving. In fact, an appreciable increase in volume is observed owing to the disorganization of the fibers through the effect of the compressed air.

This overthickness may result in the join fracturing in the glass-strand conversion processes requiring a certain path of the strand during its conversion, for example between the rolls of a tensioning device or in dies, especially when obtaining a composite. For example, this problem is particularly critical in a hot-melt process, as described above, when the join passes into the die for impregnating the fibers with the matrix, the diameter of which die is usually close to twice the thickness of the initial roving of a glass-fiber package; and

c) the presence of free glass filaments at both ends of the join:

These free filaments are sources of filament breakage and fracture initiation in the join, for example when the joins passes over the spreader or tensioner rolls or in the impregnation dies.

Furthermore, these free filaments consequently accumulate in the impregnation die, are therefore an additional source of fiber abrasion, and locally modify the viscosity of the molten plastic.

In the second method, the wrapping around the join obtained by intermingling of the filaments makes it possible to limit the presence of free filaments at the ends of the joins. However, this wrapping again increases the thickness of the join at the splice and in principle prevents a uniform join thickness to be obtained, the operation having to be in general a manual operation.

According to a first aspect, the present invention relates to a method of obtaining a join that can be used in all continuous glass-fiber conversion processes without encountering the abovementioned problems relating to the joining of the glass strands, that is to say meeting all the mechanical, physical and chemical constraints imposed by said processes.

In its most general form, the present invention relates to a method of joining the ends of at least two glass strands or roving together, in which said ends are impregnated with a material comprising a thermoplastic or a thermoset, or with a blend of a thermoplastic and a thermoset, in an overlap region calibrated by calibrating means such as a mold/countermold assembly, said material being introduced into the calibrating means:

in molten form;

or in solid form, said material and the ends of the strands then being exposed, in the overlap region, to means for at least partially, and preferably completely, melting the material.

Without being limited thereto, said melting means fall for example within the group of laser, electrical and infrared heating means and, in general, any convective, conductive or radiative heating means.

According to a preferred embodiment, the present invention relates to a method of joining at least two glass strands together, in which a coupler, consisting of or comprising a thermoplastic or a thermoset, or a blend of a thermoplastic and a thermoset, which is sensitive to ultrasound, is applied in the overlap region to the ends of the strands to be joined and then said coupler and the ends of the strands are subjected in the overlap region to mechanical vibrations within the ultrasound range, the frequency, amplitude and duration of which allow the coupler and the join between the strands to be at least partially, and preferably completely, melted.

The expression “sensitive to ultrasound” is understood to mean, within the context of the present description, that the material itself absorbs ultrasound or includes at least one component that absorbs ultrasound and is heated under the action of such ultrasonic waves, in a proportion capable of at least partially melting the thermoplastic.

The fastening system obtained, resulting from a process incorporating the addition of an additional material and preferably the use of an ultrasonic welding technique, produces, according to the invention, a composite join, having surprisingly effective characteristics and mechanical properties, as will be described later. In particular, the term “composite join” is understood to mean an assembly having the structure of a composite, that is to say being characterized by fiber/matrix coupling that guarantees the required mechanical properties. The join thus produced may be of very short length, does not generate free filaments at the ends of the join, and has mechanical properties and thickness characteristics allowing it to be used in the processes described above.

Surprisingly, it has been observed that the use of thermoplastic matrices melted, for example by application of ultrasonic vibrations in the presence of the glass filaments, provides, in the overlap region, a composite join comprising particularly strong bonds and having surprisingly enhanced mechanical properties. The invention thus makes it possible to obtain continuous strands having a tensile strength slightly lower than, but comparable with, that of the initial glass fiber, that is to say without a join. Thus, the observed tensile strength values of the joins according to the invention (see the examples provided) are equal to or greater than 70%, most often equal to or greater than 80% and more particularly close to, or even greater than, 85% when ultrasonic vibrations are used, of the tensile strength value of the roving itself.

Without this being tied down to, or interpreted as, any particular theory, the surprisingly high tensile strength values of the continuous strand incorporating the coupler according to the invention, whatever the melting means used, could be explained by a strong interaction between at least one of the constituents of the size used when manufacturing the roving, and of the thermoplastic used. According to one possible explanation, during formation of the join, the molten thermoplastic could react with one or more of the components of the size already present on the fiber, in particular the bonding systems of sizes, such as for example silane or its derivatives, and thus could provide, in addition to the mechanical fastening, a chemical bond between the filaments, which greatly contributes to enhancing the mechanical strength properties of the join finally obtained between the strands or rovings.

Furthermore, the improved mechanical properties of the join consequently allow the length of the join to be greatly reduced, down to a length of around a few centimeters, for example ranging from 1 to 5 cm, or even of the order of 1 centimeter.

In addition, by joining the glass fiber filaments together using a thermoplastic it is possible to prevent any free filaments present at the ends of the join. Advantageously, to ensure that there are no free filaments, the thermoplastic is deposited over a very slightly greater length than that of the superposition of the two rovings of the packages thus joined.

According to the preferred way of implementing the method, the use of an ultrasonic welding technique for obtaining the join also has several advantages:

The first advantage is that the strength of the composite join between the glass fiber packages is further increased by the use of the ultrasonic welding technique applied to the glass fiber. In addition, the ultrasonic technique allows the thermoplastic to be melted very rapidly and incurs no risks both as regards production of the joins and as regards the human factor, that is to say the safety of operators.

According to one possible theory for explaining the even greater strength of the join obtained using this mode of implementation, the combined use of ultrasound and a thermoplastic that reacts strongly to the ultrasonic stresses could provide better fastening because of:

the partial dissociation of the constituent filaments of the roving that results therefrom; and

the penetration of the molten matrix right into the core of the roving, so as to surround the partly dissociated filaments, again under the effect of the ultrasonic vibrations.

The use of vibrations within the ultrasound range thus makes it possible not only to increase the contact area but also the quality of the interface between the glass and the molten thermoplastic.

The combined use of ultrasound and a thermoplastic promotes the creation of a join having improved mechanical properties. In particular, the trials carried out by the Applicant, which are reported in the examples that follow, have shown that, in this mode of implementation, the tensile strength is surprisingly comparable to that of the initial glass fiber roving.

In the ultrasonic welding technique, the thermoplastic is at least partially, and preferably completely, melted under the effect of vibrations at frequencies within the ultrasound range, in general between 20 and 100 kHz, preferably between 20 and 40 kHz, and with a very small amplitude adapted according to the frequency used, so as not to break or crack the glass filaments. In practice, the amplitude is in general smaller the higher the vibration frequency. Depending on the frequency used, the vibration amplitude will typically be between 0.1 and 1 mm, preferably between 0.1 and 0.5 mm. The duration of the ultrasound treatment is of course chosen according to the frequency and the amplitude of the ultrasound and according to the time needed under these conditions to at least partially, and preferably completely, melt the thermoplastic. For an industrial application, the duration is in general a few seconds, preferably around one second.

Advantageously, welding using the ultrasonic technique allows the thickness of the join to be calibrated. To do this, it is advantageous to use a vibration device for generating vibrations at an ultrasonic frequency, normally used for producing a bond between thermoplastics, such as the devices developed and sold by the companies Rinco Ultrasonic and Branson Ultrasonics. As is known, the device comprises a sonotrode set in vibration by a piezoelectric transducer. The piezoelectric device converts electrical energy into mechanical vibrations within the ultrasound range. Advantageously, the device employed according to the invention is formed from two parts: a machined and calibrated support for presenting, in an approximately central position, a channel of approximately semicylindrical shape of defined radius and an upper part, also comprising a channel of the same semicylindrical shape. The two parts are mounted in such a way that when the support and the upper part are assembled they thus form a duct of cylindrical shape, the diameter of which is approximately equal to the diameter of the join finally obtained. The support and the upper part of the device thus form a calibrated mold/countermold, allowing the shape and the regularity of the join obtained to be checked. Finally, the method makes it possible to have very small and regular overthickness, which may advantageously be less than twice the thickness of the initial strand. The upper part of the device is connected to a piezoelectric transducer for applying the ultrasonic wave to the fiber portion and to the thermoplastic to be melted.

Preferably, the thermoplastic used is selected according to the subsequent conversion process carried out on the fiber or process for manufacturing a composite, for example taking into account the compatibility of said thermoplastic with the matrices used in the conversion processes.

According to another example, within the context of hot-melt impregnation methods for producing thermo-plastic granulates reinforced with glass fibers, the thermoplastics used for producing the join are selected so as to have a high level of compatibility with the matrix used in the composite and also a melting point slightly higher than that of the matrix, for example at least 5° C. higher and preferably at least 10° C. higher, so that the join retains all of its qualities and characteristics during conversion of the glass fiber.

According to the invention, the thermoplastic used as join comprises, for example, a matrix based on a polymer chosen from polypropylenes (PP), polyamides (PA), polyethylene terephthalates (PET), polybutylene terephthalates (PBT), and acrylonitrile-butadiene-styrene copolymers (ABS).

It is known that the sensitivity to ultrasound of thermoplastics can vary, for example depending on the length of the molecular chains. According to the invention, the frequency/amplitude range is adapted to the use of a thermoplastic. Said thermoplastic is itself adapted to its use as a join, according to well-known techniques for ultrasonic thermoplastic welding. In particular, the thermoplastic in question may advantageously have a form particularly suitable for rapid use, that is to say the lowest possible welding time. In general, the thermoplastic coupler is of flat shape with a small thickness and width. For example, the length of the coupler ranges from about 0.1 cm to 3 cm, and more particularly between 0.5 cm and 1 cm. Its width is advantageously larger than that of the glass strands to be welded, in order to make it easier to install it. The surplus is for example cut off by the mold and countermold used during the ultrasonic welding and provided for this purpose. The thickness of the coupler varies from 50 μm to 2 mm and preferably from 100 μm to 1 mm.

The advantages associated with implementation of the present invention are illustrated by the following examples, provided purely by way of illustration. Of course, these examples must not, in any of the aspects described, be considered as limiting the invention.

### EXAMPLE 1

In this example, two packages of glass strands in the form of rovings, with a diameter of 17 μm and a linear density of 2400 tex, were joined together according to the invention. The join was produced using an ultrasonic vibration device sold by Rinco Ultrasonic and as described above. The two roving ends of the packages were firstly superposed over a length of 1 cm in contact with a thermoplastic comprising a polypropylene matrix, sold by 3M under the reference Thermobond Film 845® with a thickness of 100 μm. The width of the coupler was fixed in this example to 1 cm and its length to 2 cm, in the hemispherical channel of the support. After positioning the upper part, the assembly was then subjected to ultrasound waves of 35 kHz frequency with a vibration amplitude of 0.5 mm. The duration of the treatment was 1 second. After treatment, a uniform bond with a length of 1 cm±2 mm and a diameter substantially equal to, or even less than, twice that of the initial strand, was removed from the mold/countermold system. Visual observation revealed no free glass filaments at the two ends of the join.

In total, ten successive trials were performed in order to measure the tensile strength using the ISO 3341 method.

### EXAMPLE 2 (COMPARATIVE)

In this example, a roving of the same nature as that described in Example 1 was used, but having no join. The tensile strength was measured in the same way as in Example 1.

### EXAMPLE 3 (COMPARATIVE)

In this example, two strands of the same nature as that described in Example 1 were spliced over a length of 10 cm using the “air splice” technique of the prior art, described above. The tensile strength was measured in the same way as in Example 1. The join had a diameter of 2.5 to 3 mm, but its appearance was irregular because of the increase in volume of the strand due to the compressed-air technique used.

### EXAMPLE 4 (COMPARATIVE)

In this example, two strands of the same nature as that described in Example 1 were attached using the “air splice” technique of the prior art described above, using the same protocol, and then the join obtained was wrapped with polyamide yarns in order to increase the tensile strength. The tensile strength was then measured in the same was as in Example 1.

### EXAMPLE 5

In this example, two glass strand packages in the form of rovings were joined together under the same conditions as those described in Example 1 except that this time a coupler comprising a thermoplastic/thermo-set blend sold by 3M under the reference Scotchweld 583® was used to establish the join. The thickness of the thermoplastic/thermoset coupler was 0.15 mm.

### EXAMPLE 6

In this example, a thermoplastic matrix was introduced hot into a mold/countermold device in contact with the ends of the strands, as described above. The material was introduced in liquid form by means of a deposition system of the hot-melt type (that is to say allows deposition of molten thermoplastic). The equipment used was that sold by Nordson under the name “Dispensing gun-classic hotmelt”. The thermoplastic used was a polypropylene, sold in powder, granule or rod form.

Table 1 gives the experimental tensile strength values of the various strands, obtained for the six examples described above:

TABLE 1
Average tensile strength values determined on various joins

| | | | | | | Example 5: | |
|---|---|---|---|---|---|---|---|
| | | | | | | Ultrasound + | |
| | | | | Example 4: | | “hybrid” | Example 6: |
| | | Example 2: | Example 3: | Air-splice | Example 1: | thermoplastic/ | Hot-melt |
| | Trial | Strand | Air-splice | join + | Ultrasound + | thermoset | deposition |
| | No. | without join | join | wrapping | thermoplastic | blend | system |
| Tensile | 1 | 102.24 | 34.87 | 38.18 | 86.43 | 84.12 | 79.58 |
| strength | 2 | 99.75 | 29.64 | 43.31 | 88.76 | 82.45 | 80.32 |
| (DaN) | 3 | 103.45 | 28.34 | 50.34 | 80.34 | 81.66 | 80.44 |
| | 4 | 102.56 | 29.31 | 49.23 | 89.77 | 82.69 | 78.99 |
| | 5 | 105.67 | 27.34 | 55.56 | 85.79 | 82.14 | |
| | 6 | 99.66 | 32.03 | 38.45 | 88.55 | 80.80 | |
| | 7 | 98.56 | 25.78 | 42.76 | 89.23 | 81.44 | |
| | 8 | 104.34 | 31.66 | 38.56 | 88.65 | 84.21 | |
| | 9 | 100.98 | 29.33 | 42.32 | 82.61 | 83.58 | |
| | 10 | 102.23 | 26.98 | 44.44 | 84.7 | 81.56 | |

| | | | | | | |
|---|---|---|---|---|---|---|
| Av. (DaN) | 101.94 | 29.53 | 44.32 | 86.48 | 82.44 | 79.83 |
| Stand. dev. | 2.23 | 2.71 | 5.77 | 3.14 | 1.28 | 0.67 |
| Max. | 105.67 | 34.87 | 55.56 | 89.77 | 84.21 | 80.44 |
| Min. | 98.56 | 25.78 | 38.18 | 80.34 | 80.80 | 79.58 |
| Av. (%) | 100.00% | 28.96% | 43.47% | 84.83% | 80.87 | 78.31 |

It may be seen that the continuous strand obtained according to the invention has an extremely high tensile strength, the average value obtained being more than twice that obtained using the air-splice method and very much greater than that obtained using the “air splice+wrapping” method, whatever the method used of impregnating the fiber with the coupler. The results obtained demonstrate the surprising strength of the join obtained according to the invention, compared with the strength of the initial roving, without a join. Such properties make it possible, without fear of the continuous strand, formed by rovings joined together by couplers according to the invention, breaking, for said continuous strand to be applied in the processes described above, and in general in all processes in which the strand is subjected to a high tensile force and/or passes through a calibrated die. Furthermore, the join thus produced may be very short and does not cause problems associated with the presence of free filaments at the ends of the joins between rovings.

1. A method of joining the ends of at least two glass strands together, in which said ends are impregnated with a material comprising a thermoplastic or a thermoset, or with a blend of a thermoplastic and a thermoset, in an overlap region calibrated by calibrating means, said material being introduced into the calibrating means:
in molten form;
or in solid form, said material and the ends of the strands then being exposed, in the overlap region, to means for at least partially, and preferably completely, melting the material.

2. The joining method as claimed in claim 1, in which the length of the overlap region is between 1 and 5 cm.

3. The joining method as claimed in claim 1, in which the material is deposited over a length greater than the overlap region of the strands.

4. The joining method as claimed in claim 1, in which a coupler, consisting of or comprising a thermoplastic or a thermoset, or a blend of a thermoplastic and a thermoset, which is sensitive to ultrasound, is applied in the overlap region to the ends of the strands to be joined and then said coupler and the ends of the strands are subjected in the overlap region to mechanical vibrations within the ultrasound range, the frequency, amplitude and duration of which allow the coupler and the join between the strands to be at least partially, and preferably completely, melted.

5. The joining method as claimed in claim 4, in which the frequency of the vibrations is between 20 and 100 kHz, preferably between 20 and 40 kHz.

6. The joining method as claimed in claim 4, in which the vibration amplitude is between 0.1 and 1 mm, preferably between 0.1 and 0.5 mm.

7. The joining method as claimed in claim 4, in which the duration is between 1 and 3 seconds, preferably around 1 second.

8. The joining method as claimed in claim 4, in which the mechanical vibrations are obtained by employing a device comprising a sonotrode set in vibration by a piezoelectric transducer.

9. The joining method as claimed in claim 8, in which the device includes a calibrated, cavity defining and surrounding the overlap region in order to check the shape and regularity after employing the sonotrode.

10. The joining method as claimed in claim 1, in which the thermoplastic is selected according to the subsequent conversion process carried out on the joined strand or process for manufacturing a composite from the joined strand, especially according to the compatibility of said thermoplastic with the matrices used in the conversion or manufacturing processes.

11. The joining method as claimed in claim 1, in which the thermoplastic comprises a matrix based on a polymer chosen from polypropylenes (PP), polyamides (PA), polyethylene terephthalates (PET), polybutylene terephthalates (PBT), and acrylonitrile-butadiene-styrene copolymers (ABS).

12. A continuous strand able to be obtained by the method as claimed in claim 1, comprising an overlap region in which the ends of two base strands are joined by means of a thermoplastic, thermoset or a blend of a thermoplastic and a thermoset present between the constituent filaments of said strands.

13. The method of using the continuous strand as claimed in claim 12 in a process in which said strand is subjected to a high tensile force and/or passes through a calibrated die, such as processes of the thermoplastic pultrusion type for obtaining long-fiber granulates, or direct, injection molding or compression molding, long-fiber processes resulting in the direct production of a part made of a composite, or processes for manufacturing textile surfaces, such as knitting and weaving, or processes for manufacturing chopped-strand or continuous-strand mats.
